(19) United States
(12) Patent Application Publication
(10) Pub. No.: US 2023/0098035 A1
(43) Pub. Date: Mar. 30, 2023

(54) INFORMATION PROVIDING SYSTEM AND INFORMATION PROVIDING METHOD

(71) Applicant: HONDA ACCESS CORP., Niiza-shi (JP)

(72) Inventor: Koji Yoshioka, Niiza-shi (JP)

(73) Assignee: HONDA ACCESS CORP., Niiza-shi (JP)

(21) Appl. No.: 17/947,539

(22) Filed: Sep. 19, 2022

(30) Foreign Application Priority Data
Sep. 28, 2021 (JP) 2021-158318

(51) Int. Cl. G06Q 30/06; G06Q 50/00

(52) U.S. Cl. CPC G06Q 30/0631; G06Q 30/0633; G06Q 50/01

(57) ABSTRACT

An information providing system 1 includes: an item list generator 55 that generates a match-pair list including items associated with a subject user based on information registered in a user profile database 51 and information registered in an item profile database 52; a session information processing system 6 that acquires session information in a session with the subject user via a user interface 2 and calculates a target social position of the subject user in a social space formed by reflection of sense of values of a plurality of registered users registered in the user profile database 51, based on the session information; and an item proposer 7 that proposes items to the subject user based on the match-pair list and the target social position.

This application is based on and claims the benefit of priority from Japanese Patent Application No. 2021-158318, filed on 28 Sep. 2021, the content of which is incorporated herein by reference.

### BACKGROUND OF THE INVENTION

### Field of the Invention

The present invention relates to an information providing system and an information providing method. More specifically, the present invention relates to an information providing system and an information providing method for proposing an item suitable for a hobby and taste of a subject user out of a plurality of registered items registered in an item profile database.

### Related Art

An information providing method disclosed in Japanese Unexamined Patent Application, Publication No. 2001-282833 includes a step of collecting customer information on a real shop and a virtual shop on the Internet, a step of extracting personal information for each customer from the collected customer information, a step of analyzing a hobby and a purchase pattern on a customer-by-customer basis based on the personal information, a step of creating needs information beneficial to customers related to the analysis results, and a step of providing the created needs information to each of the customers via the Internet. According to the information providing method disclosed in Japanese Unexamined Patent Application, Publication No. 2001-282833, it is possible to provide information with which the customers are satisfied.
Patent Document 1: Japanese Unexamined Patent Application, Publication No. 2001-282833

### SUMMARY OF THE INVENTION

In many of the conventional information providing methods as described above, information suitable for a hobby and taste of a user can be provided using a database subjected to curation, but this merely makes it possible to provide information with a high level of satisfaction only to 60% to 70% of users, who belong to a so-called follower group.

In other words, since the method based on the database subjected to curation is focused entirely on the proposal based on a general scale, it has poor followability for some users called superfans having strong intentionality. Further, for example, a database generated based on reviews on the Internet is static. Therefore, in industries such as restaurants that are frequently subjected to the whims of fashion, such a database is effective for users belonging to the follower group, but cannot provide information with a high level of satisfaction to users who belong to a so-called advanced group always seeking new things and users who belong to a so-called standard group always seeking the standard things.

The present invention is to provide an information providing system and an information providing method capable of proposing items with a high level of satisfaction to more users.

(1) An aspect of the present invention is directed to an information providing system (for example, an information providing system 1 to be described below) for proposing an item suitable for a subject user out of a plurality of registered items registered in an item profile database (for example, an item profile database 52 to be described below). The information providing system includes: an item list generator (for example, an item list generator 55 to be described below) that generates an item list including one or more items associated with the subject user based on information on the subject user registered in a user profile database (for example, a user profile database 51 to be described below) and information registered in the item profile database; a session information processing system (for example, a session information processing system 6 to be described below) that acquires session information in a session with the subject user via a user interface (for example, a user interface 2 to be described below) of the subject user, and calculates a target social position of the subject user in a social space formed by reflection of sense of values of a plurality of registered users registered in the user profile database, based on the session information; and an item proposer (for example, an item proposer 7 to be described below) that proposes one or more items to the subject user based on the item list and the target social position.

(2) In this case, preferably, the session includes repeating several times a proposal process (for example, see step ST3 to be described below) in which the item proposer tentatively proposes a plurality of items to the subject user and a selection process (for example, see step ST4 to be described below) in which the subject user tentatively selects at least one item from the plurality of items proposed by the item proposer, and the session information includes information on the items selected by the subject user in the selection process.

(3) In this case, preferably, the session information processing system calculates the target social position based on a change history of a social position of the subject user in the social space within the session.

(4) In this case, preferably, the session information processing system includes: a user vector generator (for example, a user vector generator 62 to be described below) that generates user vectors for the registered users on a user-by-user basis, based on information registered in the user profile database; and a user vector storage (for example, a user vector storage 60 to be described below) that stores the user vectors generated by the user vector generator, and the social space is defined based on the user vectors of the plurality of registered users.

(5) In this case, preferably, the session information processing system includes: an item vector generator (for example, an item vector generator 63 to be described below) that generates item vectors for the registered items on an item-by-item basis, based on information registered in the item profile database; and an item vector storage (for example, an item vector storage 61 to be described below) that stores the item vectors generated by the item vector generator, and the item proposer proposes one or more items to the subject user based on the item vector and the target social position associated with each other by the item list.

(6) In this case, preferably, the session information processing system further includes a user vector updater (for example, a user vector updater 64 to be described below) that updates, based on the session information, the user vector of the subject user stored in the user vector storage.

(7) In this case, preferably, the user vector updater updates the user vector of the subject user based on an item vector associated with the session information.

(8) In this case, preferably, the session information processing system further includes an item vector updater (for example, an item vector updater 65 to be described below) that defines an item vector associated with the session information as a selected item vector and updates the selected item vector stored in the item vector storage, based on the user vector of the subject user.

(9) In this case, preferably, the session information processing system further includes a centroid boundary calculator (for example, a centroid boundary calculator 66 to be described below) that calculates a centroid and a boundary of a user vector space of the user vectors of the plurality of registered users stored in the user vector storage, and the social space is defined based on the centroid and the boundary.

(10) Preferably, the session information processing system further includes: a social position calculator (for example, a social position calculator 67 to be described below) that calculates a social position of the subject user in the social space based on the user vector of the subject user; a session vector generator (for example, a session vector generator 68 to be described below) that generates a session vector based on a change history of the social position of the subject user within the session; and a target social position calculator (for example, a target social position calculator 69 to be described below) that calculates the target social position based on the social position of the subject user and the session vector.

(11) In this case, preferably, the target social position calculator calculates the target social position by synthesizing a latest social position of the subject user and a change target of the social position of the subject user estimated based on the session vector.

(12) In this case, preferably, the item proposer calculates a score for each of the items included in the item list based on the target social position, the session vector, and the item vector, and proposes the items in descending order of the score.

(13) Another aspect of the present invention is directed to an information providing method for proposing, by a computer (for example, an information providing system 1 to be described below), an item suitable for a subject user out of a plurality of registered items registered in an item profile database (for example, an item profile database 52 to be described below). The information providing method includes: a process (for example, see step ST2 to be described below) of generating an item list including one or more items associated with the subject user based on information on the subject user registered in a user profile database (for example, a user profile database 51 to be described below) and information registered in the item profile database; a process (for example, see step ST4 to be described below) of acquiring session information in a session with the subject user via a user interface of the subject user; a process (for example, see step ST7 to be described below) of calculating a target social position of the subject user in a social space formed by reflection of sense of values of a plurality of registered users registered in the user profile database, based on the session information; and a process (for example, see step ST8 to be described below) of proposing one or more items to the subject user based on the item list and the target social position.

(1) In the information providing system according to the present invention, the item list generator generates the item list including one or more items associated with the subject user, based on the information on the subject user registered in the user profile database and the information registered in the item profile database, the session information processing system acquires the session information in the session with the subject user via the user interface of the subject user and calculates the target social position of the subject user in the social space formed by reflection of the sense of values of the plurality of registered users based on the session information, and the item proposer proposes one or more items based on the item list and the target social position. The present invention makes it possible to propose the items with a high level of satisfaction to a large number of users who mainly belong to a follower group, by first proposing the items to the subject user using the item list generated based on the information registered in the user profile database and the item profile database.

By the way, according to Immanuel Kant's personality model, “will” can be defined as an action from one's self-perceived “current state” toward a “goal” as the person one wants to be, and the degree of the action can be defined as a level of well-being, that is, a level of satisfaction. According to the present invention, the session information processing system can calculate, as the target social position, the “goal” according to the above personality model for the subject user at the time of execution of a session by calculating the target social position of the subject user in the social space based on the session information acquired in the session with the subject user. Further, according to the present invention, the item proposer proposes the items to the subject user based on the item list and the target social position, and thus can also propose the items with a high level of satisfaction to users who belong to a superfan group, an advanced group, a standard group, or the like other than a follower group.

(2) The session information processing system can acquire, as the session information, the information on the item selected by the subject user in the session with the subject user including the repetition of the proposal process and the selection process for several times, and can calculate the target social position based on the session information, thereby calculating the target social position of the subject user while reflecting the sense of values of the subject user at the time of execution of the session, such as a hobby, a taste, and an interest. This feature makes it possible to propose the items with a high level of satisfaction to more users.

(3) The session information processing system can calculate the target social position based on the change history of the social position of the subject user in the social space within the session, and can calculate the target social position of the subject user while accurately reflecting the sense of values of the subject user at the time of execution of the session. This feature makes it possible to propose the items with a high level of satisfaction to more users.

(4) The user vector generator generates the user vectors for the registered users on a user-by-user basis, based on the information registered in the user profile database, and the user vector storage stores the user vectors generated by the user vector generator. In the present invention, the session information processing system defines the social space, in which the target social position is defined, based on the user vectors of the plurality of registered users. This feature makes it possible to define the social space while reflecting the sense of values of a virtual society constituted by the plurality of registered users registered in the user profile database.

(5) The item vector generator generates the item vectors for the registered items on an item-by-item basis, based on the information registered in the item profile database, the item vector storage stores the item vectors generated by the item vector generator, and the item proposer proposes one or more items to the subject user based on the item vector and the target social position associated with each other by the item list. This feature makes it possible to quantitatively extract, from the plurality of items included in the item list, items that increase the “level of well-being” referred to in the personality model, and to propose the extracted items to the subject user.

(6) The user vector updater updates the user vector of the subject user stored in the user vector storage based on the session information. This feature makes it possible to cause the user vector of the subject user to reflect the sense of values of the subject user at the time of execution of the session.

(7) The user vector updater updates the user vector of the subject user based on the item vector associated with the session information. This feature makes it possible to quantitatively evaluate the sense of values of the subject user at the time of execution of the session and to cause the user vector of the subject user to reflect the sense of value.

(8) The value of the registered item in a society as a whole is not universal from when the registered item is registered in the item profile database, and changes from moment to moment as the sense of values of the society as a whole changes. Therefore, the item vector updater updates the selected item vector associated with the session information of the subject user among the plurality of item vectors stored in the item vector storage, based on the user vector of the subject user. Thus, the item vectors can be updated in accordance with the change in the sense of values of the society as a whole, that is, so that the item vectors follow the whims of fashion. This feature makes it possible to maintain the item vectors stored in the item vector storage with high freshness. Maintaining the item vectors with high freshness in this way enables proposal of the items with a high level of satisfaction to the subject user.

(9) The sense of values of the society as a whole changes from moment to moment, regardless of changes in the sense of values of oneself as a member of the society. In particular, the sense of values of the users who belong to the superfan group or the advanced group, change dramatically, and the sense of values of the society as a whole changes accordingly. To address these changes, the centroid boundary calculator of the present invention calculates centroids and boundaries of the user vector space of the user vectors of the plurality of registered users stored in the user vector storage, and the session information processing system defines the social space based on the centroids and boundaries of the plurality of registered users. Thus, since the social space can be defined in accordance with the changes in the sense of values of the society as a whole, the social position of the subject user in the society as a whole can be corrected in accordance with changes in the sense of values of the society as a whole.

(10) The social position calculator calculates the social position of the subject user in the social space based on the user vector of the subject user, the session vector generator generates the session vector based on the change history of the social position of the subject user within the session, and the target social position calculator calculates the target social position based on the session vector obtained by reflection of the social position of the subject user and the change history of the social position. This feature makes it possible to calculate an appropriate target social position that reflects the sense of values of the subject user at the time of execution of the session.

(11) The target social position calculator calculates the target social position by synthesizing a latest social position of the subject user and the change target of the social position of the subject user estimated based on the session vector. Thus, the target social position can be calculated based on latent needs that the subject user him/herself cannot recognize, thereby making it possible to propose to the subject user an item with a high level of satisfaction that is personalized to each individual.

(12) The item proposer calculates the score for each of the items included in the item list, based on the target social position, the session vector, and the item vector, and proposes the items in descending order of the score, thereby making it possible to propose the items in descending order of the level of satisfaction.

(13) According to the present invention, for the same reason as the invention relating to the information providing system, it is possible to propose the items with a high level of satisfaction to not only to the users who belong to the follower group but also to the users who belong to the superfan group, the advanced group, the standard group, or the like.

### BRIEF DESCRIPTION OF THE DRAWINGS

FIG. 1 is a diagram showing a configuration of an information providing system according to an embodiment of the present invention;

FIG. 2 is a diagram showing a configuration of a user profile estimator;

FIG. 3 is a diagram showing a configuration of an item profile estimator;

FIG. 4 is a diagram showing a configuration of an item list generator;

FIG. 5 is a diagram schematically showing a procedure for generating user vectors in a user vector generator;

FIG. 6 is a diagram schematically showing a procedure for generating item vectors in an item vector generator;

FIG. 7 is a diagram schematically showing a plurality of processes constituting a session with a subject user;

FIG. 8 is a diagram showing a configuration of a user vector updater;

FIG. 9 is a diagram showing a configuration of an item vector updater;

FIG. 10 is a diagram in which social positions of a plurality of registered users are plotted in a social space schematically represented on a two-dimensional plane;

FIG. 11 is a diagram showing a configuration of an item proposer;

FIG. 12 is a diagram in which item vectors of a plurality of registered items included in a match-pair list are plotted in an item vector space schematically represented on a two-dimensional plane; and

FIG. 13 is a flowchart showing a procedure of an information providing method according to the present embodiment.

### DETAILED DESCRIPTION OF THE INVENTION

An information providing system and an information providing method according to an embodiment of the present invention will be described below with reference to the drawings.

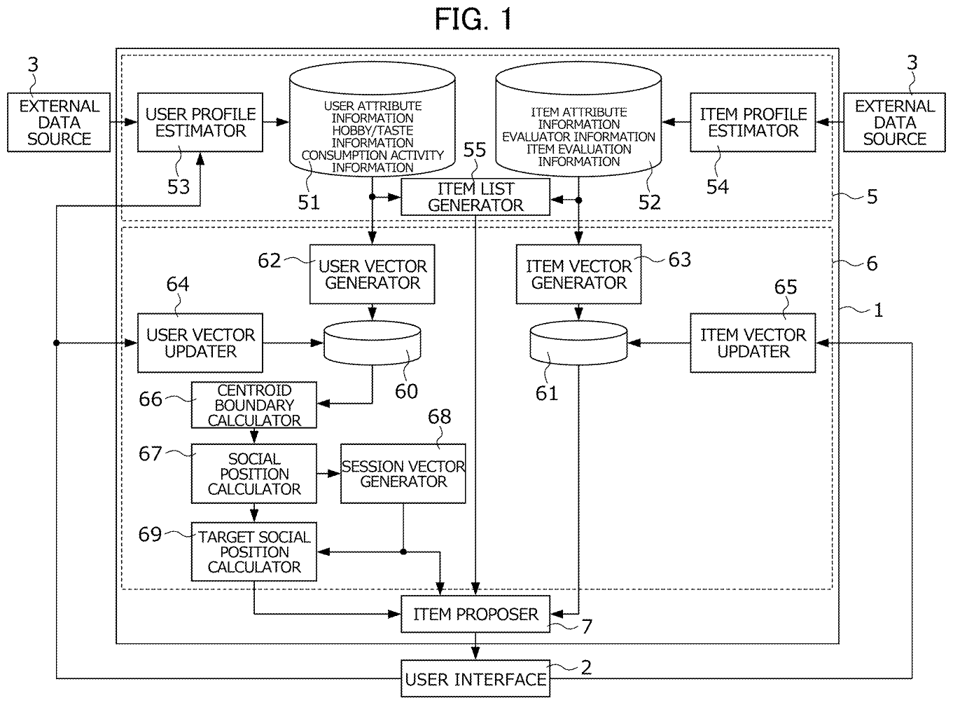

FIG. 1 is a diagram showing a configuration of an information providing system 1 according to the present invention. The information providing system 1 is a computer that includes a user profile database 51 in which a plurality of users (hereinafter, also referred to as “registered users”) and an item profile database 52 in which a plurality of items (hereinafter, also referred to as “registered items”) and manages an item proposal service that proposes information on one or more items suitable for a subject user who is one of the registered users to a user interface 2 owned by the subject user, from the plurality of registered items, according to an information providing method which will be described below.

In the present embodiment, a case will be described in which the “items” are an accommodation service provided by accommodation facilities, a food service provided by restaurants, and an experience service provided by experience facilities and the “users” are consumers who purchase the items and receive the provision of the above services, but the present invention is not limited thereto. The “items” are not limited to the services, but may be products including movable properties and real properties. Further, the “users” are not limited to the consumers, but may be providers who provide a service or a product.

In the present embodiment, a case will be described in which the “user interface” is a mobile information terminal (for example, a smartphone) in which application software for receiving the provision of the item proposal service is installed, but the present invention is not limited thereto. The “user interface” may by any computer in which software for receiving the item proposal service managed by the information providing system 1 is installed.

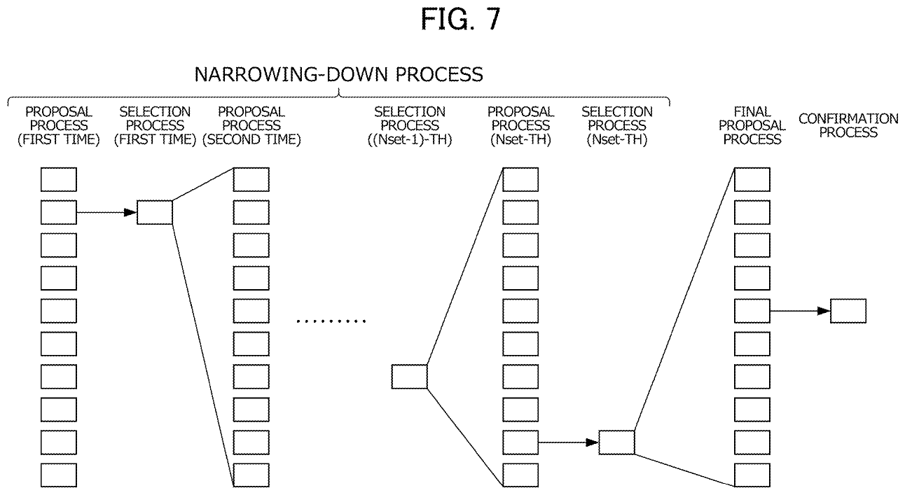

The information providing system 1 is a server system that is connected to the user interface 2, an external data source 3, or the like via a communication network (for example, the Internet) and manages the item proposal service. As shown in FIG. 1, the information providing system 1 as a server system includes a registration information processing system 5 that mainly takes charge of registration processing and update processing on information in databases 51 and 52 and processing based on the information registered in the databases 51 and 52, a session information processing system 6 that mainly takes charge of processing based on information obtained at the time of executing a session with the subject user, and an item proposer 7 that proposes information on an item to the user interface 2 of the subject user using arithmetic operation results in the registration information processing system 5 and session information processing system 6. Details of the session with the subject user in the item proposal service by the information providing system 1 will be described below with reference to FIG. 7.

<Registration Information Processing System>

First, a configuration of the registration information processing system 5 will be described. The registration information processing system 5 includes a user profile database 51, an item profile database 52, a user profile estimator 53, an item profile estimator 54, and an item list generator 55.

Personal information of each registered user is registered in the user profile database 51 in association with a user ID assigned to each registered user. The personal information registered in the user profile database 51 includes user attribute information, hobby/taste information, and consumption activity information as shown in FIG. 1.

The user attribute information includes, for example, information regarding gender and age of the registered user, and is stored in the user profile database 51 as structured data, for example. The hobby/taste information includes, for example, information regarding a hobby and taste of the registered user, and is stored in the user profile database 51 as flag data of a plurality of items, for example. In the present embodiment, a case will be described in which the hobby/taste information is represented by a plurality of types (for example, about 100 types) of taste flags that indicate the presence or absence of a specific taste of the registered user, but the present invention is not limited thereto.

Further, the consumption activity information includes, for example, information regarding a consumption activity of the registered user, and is stored in the user profile database 51 as score data of a plurality of items, for example. In the present embodiment, a case will be described in which the target of the consumption activity of the registered user is divided into a plurality of types (for example, about 30 types) of consumption segments and then the consumption activity information is represented by a score value that indicates a magnitude of the consumption activity for each consumption segment, but the present invention is not limited thereto.

Item information on each registered item is registered in the item profile database 52 in association with an item ID assigned to each registered item. The item information registered in the item profile database 52 includes item attribute information, evaluator information, and item evaluation information, as shown in FIG. 1.

The item attribute information includes, for example, information regarding an attribute of the registered item required for the user to specify the registered item, and is stored in the item profile database 52 as structured data, for example. In the present embodiment, a case will be described in which the item attribute information is represented by information on categories of the registered items (that is, in the present embodiment, accommodation facilities, restaurants, and experience facilities), information on names of the registered items, information on addresses and telephone numbers where the registered items exist, information on business days and business hours of the registered items, or the like, but the present invention is not limited thereto.

The item evaluation information includes, for example, information (so-called, word-of-mouth information) regarding objective evaluations of the registered items by consumers who have used the registered items in the past, information (so-called, advertising information) regarding subjective evaluations of the registered items by providers who provide the registered item, or the like, and is stored in the item profile database 52 as preprocessed text data, for example. Further, the evaluator information includes, for example, information regarding the consumer who provides the item evaluation information, and is stored in the item profile database 52 as structured data, for example.

The user profile estimator 53 extracts the personal information of the registered user from the data provided from the external data source 3, the user interface 2, or the like, newly registers the extracted personal information in the user profile database 51, and updates the personal information, which has been already registered in the user profile database 51, with the extracted personal information.

Here, the data provided from the external data source 3 to the user profile estimator 53 includes various data related to the user attribute information, the hobby/taste information, and the consumption activity information of the registered user, the various data including, for example, data regarding an email account associated with the registered user, email transmission/reception data associated with the email account, data regarding an SNS (Social Networking Service) account associated with the registered user, and message data associated with the SNS account.

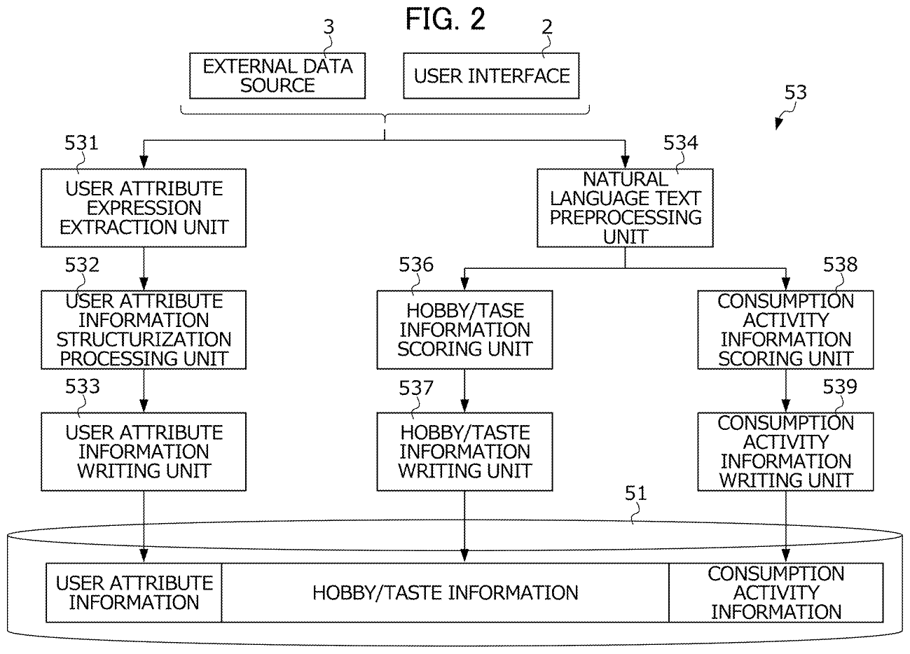

FIG. 2 is a diagram showing a configuration of the user profile estimator 53. The user profile estimator 53 includes a user attribute expression extraction unit 531, a user attribute information structurization processing unit 532, a user attribute information writing unit 533, a natural language text preprocessing unit 534, a hobby/taste information scoring unit 536, a hobby/taste information writing unit 537, a consumption activity information scoring unit 538, and a consumption activity information writing unit 539, and uses these components to extract personal information of a predetermined registered user and to write the extracted personal information to a data field of the user profile database 51.

The user attribute expression extraction unit 531 acquires data provided from the user interface 2 or the external data source 3, and processes the acquired data according to a prescribed user attribute expression extraction program to extract only user attribute information of the registered user. The user attribute information structurization processing unit 532 processes user attribute information extracted by the user attribute expression extraction unit 531 according to a prescribed user attribute information structurization program, thereby converting the user attribute information into structured data. The user attribute information writing unit 533 writes the structured data output from the user attribute information structurization processing unit 532 into a data field related to the user attribute information in the user profile database 51 in association with the user ID of the registered user.

The natural language text preprocessing unit 534 extracts text data described in natural language about the hobby and taste and the consumption activity of the registered user from the data provided from the user interface 2 or the external data source 3, and preprocesses the extracted text data according to a prescribed natural language text preprocessing program, thereby converting the extracted text data into data suitable for processing in the hobby/taste information scoring unit 536 and the consumption activity information scoring unit 538 which will be described below.

The hobby/taste information scoring unit 536 processes the text data preprocessed by the natural language text preprocessing unit 534 according to a hobby and taste scoring algorithm constructed according to machine learning, thereby calculating flag values of a plurality of items indicating the hobby and taste of the registered user. The hobby/taste information writing unit 537 writes the flag data output from the hobby/taste information scoring unit 536 into a data field related to the hobby/taste information in the user profile database 51 in association with the user ID of the registered user.

The consumption activity information scoring unit 538 processes the text data preprocessed by the natural language text preprocessing unit 534 according to a consumption activity scoring algorithm constructed according to machine learning, thereby calculating score values of a plurality of items indicating the consumption activity of the registered user. The consumption activity information writing unit 539 writes the score data output from the consumption activity information scoring unit 538 into a data field related to the consumption activity information in the user profile database 51 in association with the user ID of the registered user.

Returning to FIG. 1, the item profile estimator 54 extracts item information of the registered item from the data provided from the external data source 3, newly registers the extracted item information in the item profile database 52, and updates the item information, which has been already registered in the item profile database 52, with the extracted item information.

Here, the data provided from the external data source 3 to the item profile estimator 54 includes various data related to the item attribute information, the item evaluation information, and the evaluator information of the registered item, the various data including, for example, message data including evaluation of the registered item on SNS, data regarding an evaluator who posts the message data, data regarding evaluations of registered items on evaluation sites where evaluation of various items are published by an unspecific number of evaluators, and data regarding the evaluators.

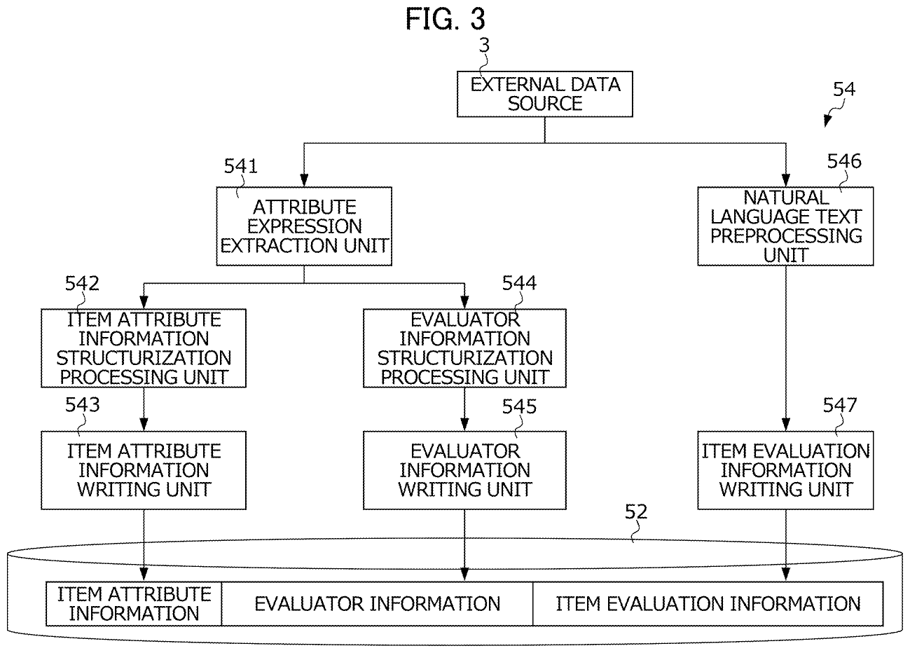

FIG. 3 is a diagram showing a configuration of the item profile estimator 54. The item profile estimator 54 includes an attribute expression extraction unit 541, an item attribute information structurization processing unit 542, an item attribute information writing unit 543, an evaluator information structurization processing unit 544, an evaluator information writing unit 545, a natural language text preprocessing unit 546, and an item evaluation information writing unit 547, and uses these components to extract item information of a predetermined registered item and to write the extracted item information to a data field of the item profile database 52.

The attribute expression extraction unit 541 acquires the data provided from the external data source 3, and processes the acquired data according to a prescribed attribute expression extraction program to extract only item attribute information and evaluator information of the registered item.

The item attribute information structurization processing unit 542 processes item attribute information extracted by the attribute expression extraction unit 541 according to a prescribed item attribute information structurization program, thereby converting the item attribute information into structured data. The item attribute information writing unit 543 writes the structured data output from the item attribute information structurization processing unit 542 into a data field related to the item attribute information in the item profile database 52 in association with the item ID of the registered item.

The evaluator information structurization processing unit 544 processes evaluator information extracted by the attribute expression extraction unit 541 according to a prescribed evaluator information structurization program, thereby converting the evaluator information into structured data. The evaluator information writing unit 545 writes the structured data output from the evaluator information structurization processing unit 544 into a data field related to the evaluator information in the item profile database 52 in association with the item ID of the registered item.

The natural language text preprocessing unit 546 extracts text data described in natural language about the evaluation of the registered item from the data provided from the external data source 3, and preprocesses the extracted text data according to a prescribed natural language text preprocessing program, thereby converting the extracted text data into data suitable for deep neural network processing (hereinafter, referred to as “DNN processing”) in the item vector generator 63 which will be described below. The item evaluation information writing unit 547 writes the text data preprocessed by the natural language text preprocessing unit 546 into a data field related to the item evaluation information in the item profile database 52 in association with the item ID of the registered item.

Returning to FIG. 1, the item list generator 55 generates, in the session with the subject user, a match-pair list including one or more registered items associated with the personal information of the subject user, based on the personal information on the subject user registered in the user profile database 51 and the item information on the plurality of registered items registered in the item profile database 52.

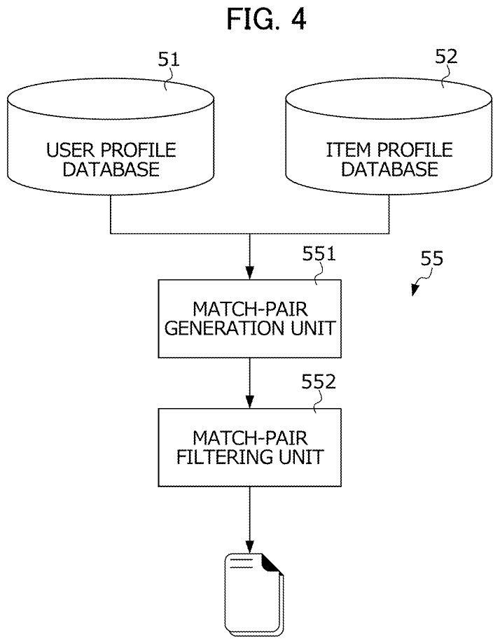

FIG. 4 is a diagram showing a configuration of the item list generator 55. The item list generator 55 includes a match-pair generation unit 551 and a match-pair filtering unit 552, and uses these components to generate a match-pair list for the subject user.

First, the match-pair generation unit 551 reads the personal information of the subject user and the item information of the plurality of registered items from the user profile database 51 and the item profile database 52, respectively, and processes the read personal information and the read item information according to a prescribed match-pair generation program, thereby extracting a plurality of registered items considered to be suitable for the subject user from the plurality of registered items registered in the item profile database 52.

The match-pair filtering unit 552 processes demands (for example, a region and a budget) of the subject user acquired by processing (not shown) from the user interface 2 and the item information of the plurality of registered items extracted by the match-pair generation unit 551 according to a prescribed match-pair filtering program, thereby generating a match-pair list including one or more, more preferably the plurality of registered items, which match the demands of the subject user and match a sense of value of the subject user inferred from the personal information registered in advance, by excluding the registered items, which do not meet the demands of the subject user, from the plurality of extracted registered items.

Returning to FIG. 1, as described above, the registration information processing system 5 appropriately updates the information registered in the databases 51 and 52 with the information provided from the external data source 3, generates the match-pair list including the plurality of registered items that match the sense of value and demands of the subject user in the session with the subject user, based on the information registered in the databases 51 and 52 at the time of start of the session, and transmits the match-pair list to the item proposer 7.

<Session Information Processing System>

Next, a configuration of the session information processing system 6 will be described. The session information processing system 6 includes a user vector storage 60, an item vector storage 61, a user vector generator 62, an item vector generator 63, a user vector updater 64, an item vector updater 65, a centroid boundary calculator 66, a social position calculator 67, a session vector generator 68, and a target social position calculator 69.

As will be described below, the session information processing system 6 acquires session information in a session with the subject user via the user interface 2 of the subject user, calculates a target social position of the subject user in a social space, which is a vector space formed by reflection of the sense of value of the plurality of registered users registered in the user profile database 51, based on the session information, and transmits the target social position to the item proposer 7. In other words, the registration information processing system 5 generates the match-pair list using the registration information before the start of the session, whereas the session information processing system 6 calculates a target social position by reflecting the sense of value of the subject user at the time of executing the session, based on the session information acquired via the user interface 2 of the subject user at the time of executing the session.

The user vector storage 60 stores a user vector defined for each registered user with respect to all of the registered users registered in the user profile database 51. The user vector space, in which these user vectors are defined, is a multi-dimensional (for example, about 100 to 300 dimensions) vector space defined by reflection of the sense of value of the user.

The plurality of user vectors stored in the user vector storage 60 are generated based on personal information registered for each registered user in the user profile database 51 by the user vector generator 62 which will be described below. When the personal information registered in the user profile database 51 is changed, the user vector of each of the registered users stored in the user vector storage 60 is updated by the user vector generator 62 by a difference resulting from such a change. Further, among the plurality of user vectors stored in the user vector storage 60, the user vector of the subject user is updated by the user vector updater 64, which will be described below, based on the session information acquired at the time of execution of the session with the subject user.

The user vector generator 62 generates user vectors in a multi-dimensional user vector space for the registered users on a user-by-user basis by DNN processing, which will be described below, based on the personal information registered for each registered user in the user profile database 51, and causes the user vector storage 60 to store the user vectors.

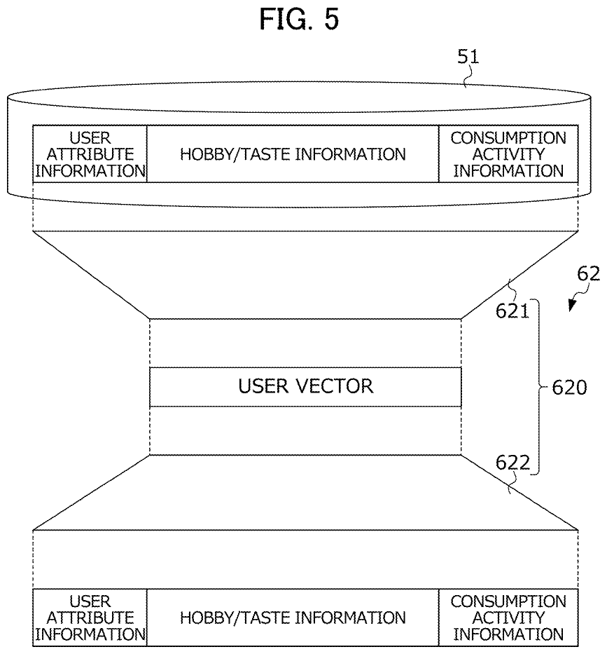

FIG. 5 is a diagram schematically showing a procedure for generating user vectors in the user vector generator 62. The user vector generator 62 includes an autoencoder 620 configured by a combination of an encoder 621 as a convolutional neural network that compresses a dimension and outputs a feature amount at the time of inputting the personal information (the user attribute information, the hobby/taste information, and the consumption activity information) of the registered user read from the user profile database 51 and a decoder 622 as a deconvolutional neural network that restores the personal information, which is input to the encoder 621 at the time of inputting the feature amount output from the encoder 621. The user vector generator 62 embeds the personal information of the registered user registered in the user profile database 51 into the user vector space, based on a known vector embedding algorithm using the autoencoder 620, thereby generating a user vector for each registered user. Further, when the registration information of the user profile database 51 is updated, the user vector generator 62 updates the user vector stored in the user vector storage 60 so as to compensate for a difference between the registration information before update and the registration information after update.

Returning to FIG. 1, the item vector storage 61 stores an item vector defined for each registered item with respect to all of the registered items registered in the item profile database 52. The item vector space, in which these item vectors are defined, is a multi-dimensional (for example, being substantially the same dimension as the user vector space and about 100 to 300 dimensions) vector space defined by reflection of the information of the item.

The plurality of item vectors stored in the item vector storage 61 are generated based on item information registered for each registered item in the item profile database 52 by the item vector generator 63 which will be described below. When the item information registered in the item profile database 52 is changed, the item vector of each of the registered items stored in the item vector storage 61 is updated by the item vector generator 63 by a difference resulting from such a change. Further, the plurality of item vectors stored in the item vector storage 61 are updated by the item vector updater 65, which will be described below, based on the session information acquired at the time of execution of the session with the subject user.

The item vector generator 63 generates item vectors in a multi-dimensional item vector space for the registered items on an item-by-item basis by DNN processing, which will be described below, based on the item information registered for each registered item in the item profile database 52, and causes the item vector storage 61 to store the item vectors.

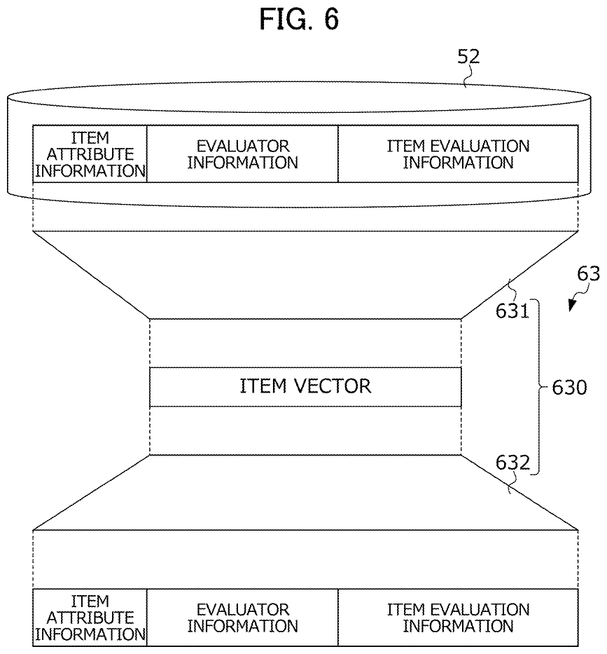

FIG. 6 is a diagram schematically showing a procedure for generating item vectors in the item vector generator 63. The item vector generator 63 includes an autoencoder 630 configured by a combination of an encoder 631 as a convolutional neural network that compresses a dimension and outputs a feature amount at the time of inputting the item information (the item attribute information, the evaluator information, and the item evaluation information) of the registered item read from the item profile database 52 and a decoder 632 as a deconvolutional neural network that restores the item information, which is input to the encoder 631 at the time of inputting the feature amount output from the encoder 631. The item vector generator 63 embeds the item information of the registered item registered in the item profile database 52 into the item vector space, based on a known vector embedding algorithm using the autoencoder 630, thereby generating an item vector for each registered item. Further, when the registration information of the item profile database 52 is updated, the item vector generator 63 updates the item vector stored in the item vector storage 61 so as to compensate for a difference between the registration information before update and the registration information after update.

Returning to FIG. 1, the user vector updater 64 updates the user vector of the subject user stored in the user vector storage 60 based on the session information acquired in the session with the subject user such that the user vector of the subject user reflects the sense of value of the subject user at the time of execution of the session.

Here, a description will be given with reference to FIG. 7 with respect to a configuration of the session with the subject user and the session information acquired from the user interface 2 of the subject user in this session.

FIG. 7 is a diagram schematically showing a plurality of processes constituting the session with the subject user. The session with the subject user is started, for example, when the subject user starts to operate an application for receiving the provision of the item proposal service from the information providing system 1 on the user interface 2. Further, the session is completed when the subject user operates the user interface 2 to confirm at least one item out of the plurality of items proposed from the information providing system 1 or when the subject user stops the application.

As shown in FIG. 7, the session with the subject user includes: a narrowing-down process in which a proposal process and a selection process are alternately repeated for a plurality number of times of setting (hereinafter, the number of times of setting being referred to as Nset); a final proposal process in which a plurality of items are finally proposed to the subject user from the information providing system 1 based on the session information obtained via the user interface 2 of the subject user in the narrowing-down process; and a confirmation process in which the subject user operates the user interface 2 to finally select (that is, confirm) at least one item from the plurality of items finally proposed in the final proposal process.

Here, in the proposal process, the item proposer 7 tentatively proposes a plurality of items to the subject user. In the selection process, the subject user operates the user interface 2 tentatively selects at least one item from the plurality of items tentatively proposed in the previous proposal process. In addition, the number of times of setting Nset in the narrowing-down process is set to, for example, an integer between 2 and a predetermined maximum number of times of setting (hereinafter, the maximum number of times of setting being referred to as Nmax). In the session with the subject user, the session information obtained by the information providing system 1 from the user interface 2 of the subject user includes, for example, information on the plurality of items tentatively proposed to the subject user in each proposal process and information on the item tentatively selected by the subject user in each selection process. In the following description, an item tentatively selected by the subject user in an n-th selection process is also referred to as an n-th selected item.

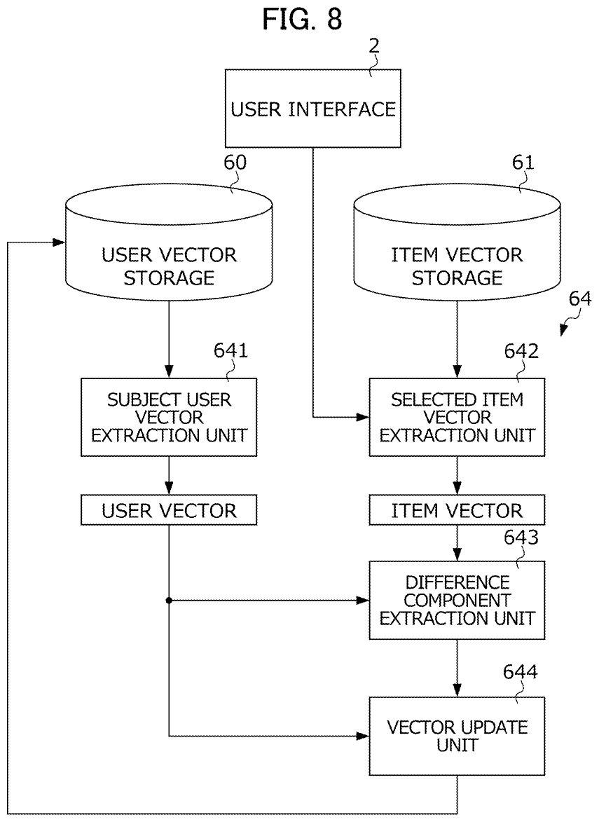

FIG. 8 is a diagram showing a configuration of the user vector updater 64. The user vector updater 64 includes a subject user vector extraction unit 641, a selected item vector extraction unit 642, a difference component extraction unit 643, and a vector update unit 644.

The subject user vector extraction unit 641 extracts a user vector of the subject user from the user vectors of all the registered users stored in the user vector storage 60, and transmits the information on the user vector of the subject user to the difference component extraction unit 643 and the vector update unit 644.

The selected item vector extraction unit 642 specifies, based on the session information acquired from the user interface 2 of the subject user, the selected item tentatively selected by the subject user in the session with the subject user, extracts an item vector of the specified selected item from the item vectors of all of the registered items stored in the item vector storage 61, and transmits information on the item vector of the selected item to the difference component extraction unit 643.

The difference component extraction unit 643 calculates a difference component between the user vector of the subject user and the item vector of the selected item, and transmits the difference component to the vector update unit 644. More specifically, the difference component extraction unit 643 calculates, as a difference component, a difference in the user vector space between the vector generated by projecting the item vector of the selected item onto the user vector space based on a predetermined algorithm and the user vector of the subject user.

The vector update unit 644 updates the user vector of the subject user based on the difference component calculated by the difference component extraction unit 643. More specifically, the vector update unit 644 updates the user vector of the subject user such that the difference component becomes smaller, and causes the user vector storage 60 to store the updated user vector. As described above, the user vector updater 64 updates the user vector of the subject user such that the user vector of the subject user becomes closer to the vector generated by projecting the item vector of the selected item onto the user vector space.

Returning to FIG. 1, the item vector updater 65 updates the item vector of the selected item stored in the item vector storage 61 based on the user vector of the subject user such that the item vector of the selected item selected by the subject user reflects the sense of value of the subject user at the time of execution of the session.

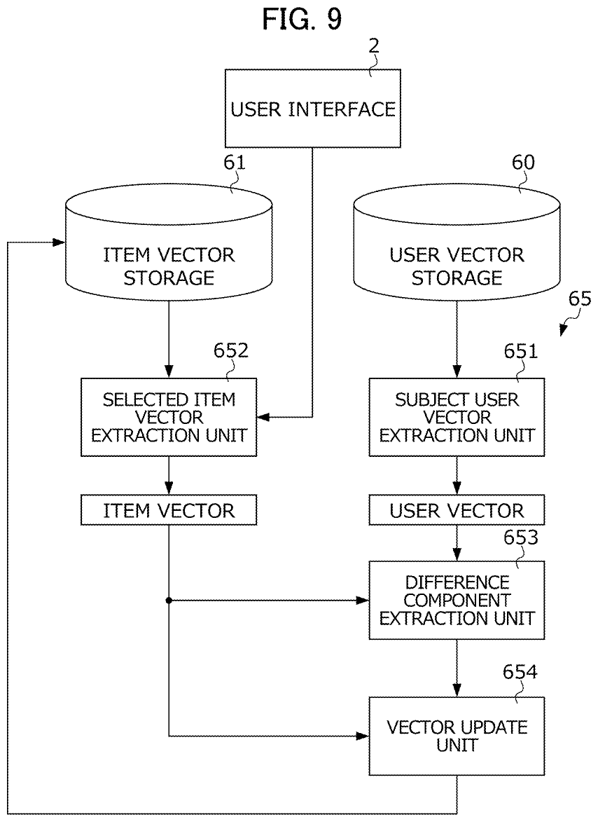

FIG. 9 is a diagram showing a configuration of the item vector updater 65. The item vector updater 65 includes a subject user vector extraction unit 651, a selected item vector extraction unit 652, a difference component extraction unit 653, and a vector update unit 654.

The subject user vector extraction unit 651 extracts a user vector of the subject user from the user vectors of all the registered users stored in the user vector storage 60, and transmits the information on the user vector of the subject user to the difference component extraction unit 653.

The selected item vector extraction unit 652 specifies, based on the session information acquired from the user interface 2 of the subject user, the selected item tentatively selected by the subject user in the session with the subject user, extracts an item vector of the specified selected item from the item vectors of all of the registered items stored in the item vector storage 61, and transmits information on the item vector of the selected item to the difference component extraction unit 653 and the vector update unit 654.

The difference component extraction unit 653 calculates a difference component between the user vector of the subject user and the item vector of the selected item, and transmits the difference component to the vector update unit 654. More specifically, the difference component extraction unit 653 calculates, as a difference component, a difference in the item vector space between the vector generated by projecting the user vector of the subject user onto the item vector space based on a predetermined algorithm and the item vector of the selected item.

The vector update unit 654 updates the item vector of the selected item based on the difference component calculated by the difference component extraction unit 653. More specifically, the vector update unit 654 updates the item vector of the selected item such that the difference component becomes smaller, and causes the item vector storage 61 to store the updated item vector. As described above, the item vector updater 65 updates the item vector of the selected item such that the item vector of the selected item becomes closer to the vector generated by projecting the user vector of the subject user onto the item vector space.

Returning to FIG. 1, the centroid boundary calculator 66 calculates centroids and boundaries in the user vector space of the user vectors of the plurality of registered users stored in the user vector storage 60, more specifically, all of the registered users, and transmits information on these centroids and boundaries to the social position calculator 67. As described above, the user vectors stored in the user vector storage 60 are appropriately updated by the user vector generator 62 and the user vector updater 64. For this reason, the centroids and boundaries of the user vectors of all of the registered users calculated by the centroid boundary calculator 66 also change every time.

The social position calculator 67 calculates, based on the user vector of the subject user, a social position indicating a position vector of the subject user in the social space which is a multi-dimensional space defined by reflection of the sense of values of all the registered users. More specifically, the social position calculator 67 defines an origin of the social space based on the centroids and boundaries of the user vectors of all the registered users calculated by the centroid boundary calculator 66, and calculates a social position of the subject user in the social space based on the user vector of the subject user. In addition, the number of dimensions of the social space is about the same as the number of dimensions of the user vector space, for example, about 100 to 300. In the session with the subject user, whenever the user vector updater 64 updates the user vector of the subject user based on the session information, that is, whenever the subject user tentatively selects the selected item, the social position calculator 67 defines a new social space and updates the social position of the subject user in the social space.

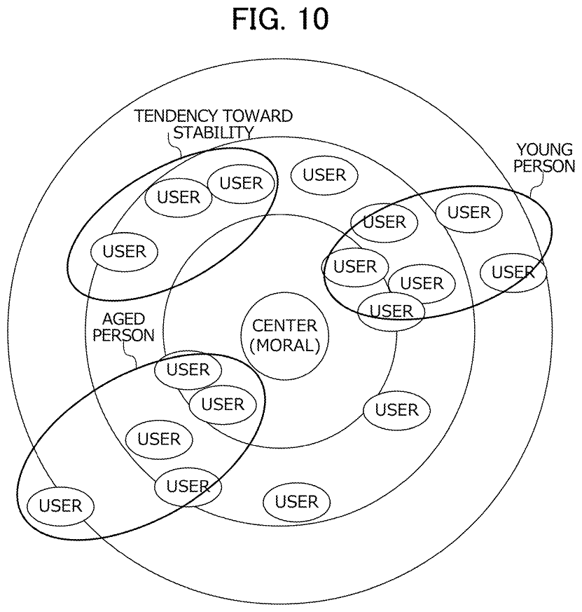

FIG. 10 is a diagram in which social positions of a plurality of registered users are plotted in a social space schematically represented on a two-dimensional plane. As shown in FIG. 10, since the social space is a multi-dimensional space defined based on the user vectors of all the registered users, that is, a multi-dimensional space defined by reflection of the sense of values of all the registered users, the social position of each of the registered users is distributed such that persons with similar sense of values (for example, aged persons, persons with a tendency toward stability, and young persons) are closer to each other. Further, an origin of such a social space is defined based on the centroid of the user vectors of all the registered users, and thus it is possible to obtain a behavior distribution of personality formation of each user from the social position in the social space.

The session vector generator 68 generates or updates the session vector of the subject user, based on a change history of the social position of the subject user, which is calculated by the social position calculator 67, within the session with the subject user. Here, the session vector is a vector representing the content of the session with the subject user, and is defined within the session vector space, which is a multi-dimensional space. As described above, since one session repeats the narrowing-down process up to Nmax times, when the number of dimensions of the social space is Ns, the number of dimensions of the session vector space is Ns×Nmax. The session vector generator 68 updates the session vector in the session with the subject user whenever the social position of the subject user is updated by the social position calculator 67. In addition, the session vector generator 68 also resets the session vector for the subject user when the session with the subject user ends. Therefore, the session vector generated or updated by the session vector generator 68 corresponds to a line traced in the social space by the social position of the subject user in the session with the subject user.

The target social position calculator 69 calculates a target social position corresponding to the target social position of the subject user at the time of execution of the session, based on the social position of the subject user calculated or updated by the social position calculator 67 and the session vector generated or updated by the session vector generator 68. More specifically, the target social position calculator 69 calculates, based on the session vector generated or updated by the session vector generator 68, a change target in the social space of the subject user, and calculates the target social position of the subject user by synthesizing the change target and the latest social position of the subject user.

Returning to FIG. 1, the item proposer 7 proposes one or more items suitable for the subject user via the user interface 2, based on the match-pair list generated by the item list generator 55, the item vector of each of the registered items stored in the item vector storage 61, the session vector generated or updated by the session vector generator 68, and the target social position calculated by the target social position calculator 69.

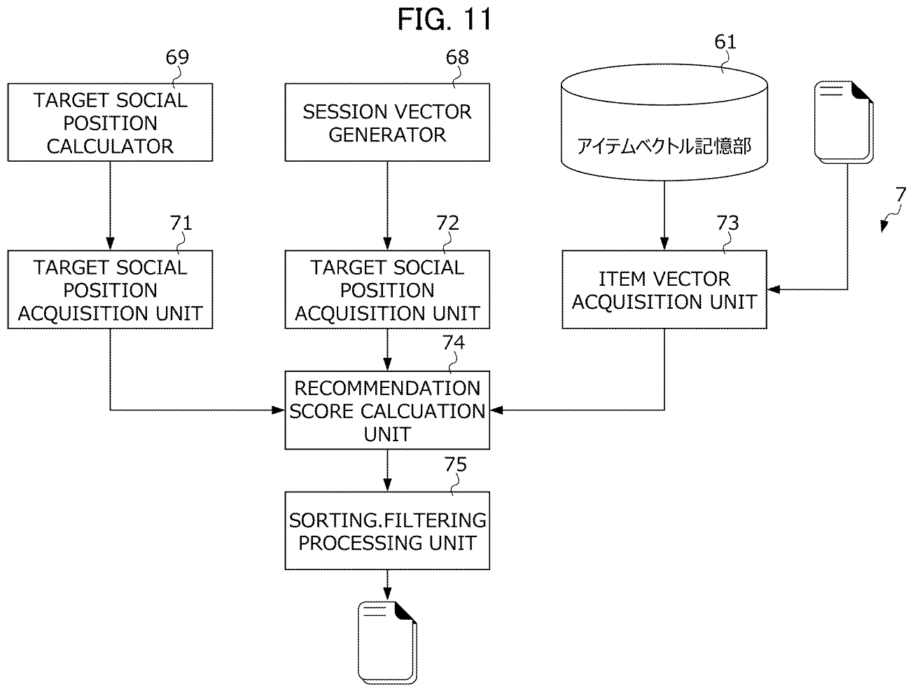

FIG. 11 is a diagram showing a configuration of the item proposer 7. The item proposer 7 includes a target social position acquisition unit 71, a session vector acquisition unit 72, an item vector acquisition unit 73, a recommendation score calculation unit 74, and a sorting/filtering processing unit 75.

The target social position acquisition unit 71 acquires the latest target social position of the subject user from the target social position calculator 69, and transmits information on the target social position to the recommendation score calculation unit 74.

The session vector acquisition unit 72 acquires the latest session vector of the subject user from the session vector generator 68, and transmits information on the session vector to the recommendation score calculation unit 74.

The item vector acquisition unit 73 acquires the item vector of the registered items included in the match-pair list from the item vectors of all the registered items stored in the item vector storage 61, and transmits information on the acquired item vector to the recommendation score calculation unit 74 in the order described in the match-pair list.

The recommendation score calculation unit 74 calculates, based on the target social position acquired by the target social position acquisition unit 71, the session vector acquired by the session vector acquisition unit 72, and the item vector acquired by the item vector acquisition unit 73, a recommendation score, which is a numerical value indicating a degree of recommendation to the subject user, for each of the registered items included in the match-pair list. More specifically, when the target social position, the session vector, and the item vector are input, the recommendation score calculation unit 74 includes DNN that is constructed by machine learning so as to output the recommendation score for the subject user of the registered item associated with such an item vector, and uses the DNN to calculate a recommendation score for each of the registered items included in the match-pair list.

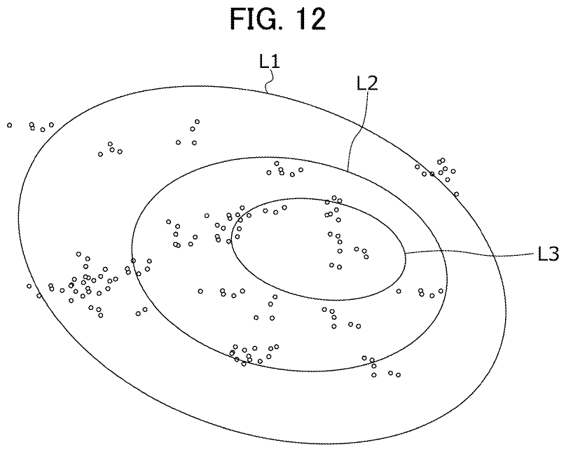

FIG. 12 is a diagram in which item vectors of a plurality of registered items included in the match-pair list are plotted in an item vector space schematically represented on a two-dimensional plane. In FIG. 12, a line L1 indicates a distribution area of registered items proposed to the subject user by the item proposer 7 in a first proposal process, a line L2 indicates a distribution area of registered items proposed to the subject user by the item proposer 7 in a second proposal process, and a line L3 indicates a distribution area of registered items proposed to the subject user by the item proposer 7 in a third proposal process.

Here, since the session vector is generated by the user vector updater 64, the user vector storage 60, the centroid boundary calculator 66, the social position calculator 67, and the session vector generator 68 based on the session information for the subject user as described above, the session vector is obtained by reflection of a selection history of the items in the session with the subject user. For this reason, the recommendation score calculation unit 74 calculates the recommendation score for the registered item by DNN processing including such a session vector as an input, thereby making the recommendation score for the registered item distributed near the registered item tentatively selected by the subject user from the plurality of registered items tentatively proposed by the item proposer 7 in the previous proposal process higher than the recommendation score for the registered item distributed near the plurality of registered items not tentatively selected by the subject user. Therefore, as shown in FIG. 12, it is possible to gradually narrow down the area in which the registered items proposed to the subject user by the item proposer 7 are distributed.

Returning to FIG. 11, the sorting/filtering processing unit 75 sorts the plurality of registered items included in the match-pair list in descending order of the recommendation score, generates a proposal list including registered items whose recommendation score is equal to or higher than a predetermined value by excluding registered items whose recommendation score is lower than the predetermined value, and transmits the proposal list to the user interface 2 of the subject user. Thereby, the item proposer 7 can propose the registered items to the subject user in descending order of the recommendation score.

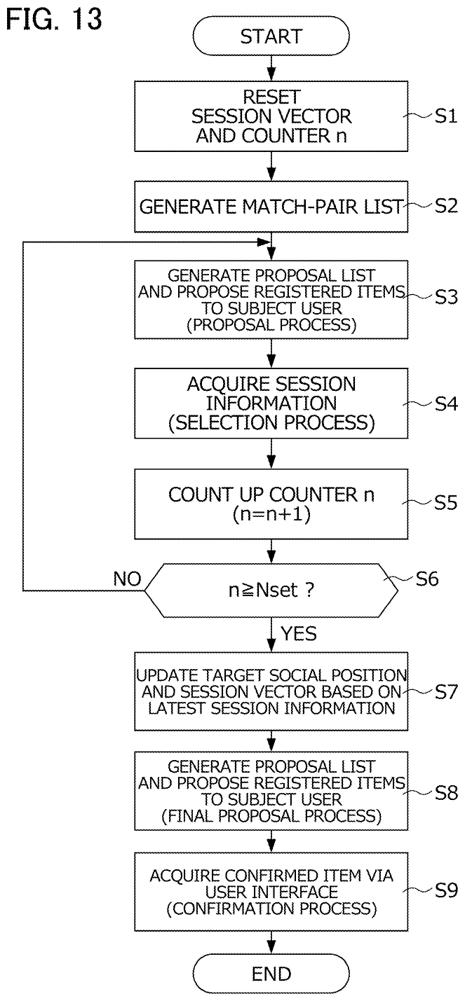

FIG. 13 is a flowchart showing a procedure of an information providing method in which the information providing system 1 as described above proposes the items to the subject user.

First, in step ST1, the session information processing system 6 resets the session vector generated in the previous session with the subject user and a counter n that counts the number of repetitions of the narrowing-down process, and the process proceeds to step ST2.

In step ST2, the registration information processing system 5 generates a match-pair list for the subject user, based on the personal information of the subject user registered in the user profile database 51 and the item information on each of the registered items registered in the item profile database 52, and the process proceeds to step ST3.

In step ST3, the item proposer 7 generates a proposal list based on the match-pair list generated in step ST2 and the target social position and the session vector generated based on the latest session information in the session information processing system 6, and tentatively proposes the registered items included in the proposal list to the subject user via the user interface 2 (proposal process), and the process proceeds to step ST4.

In step ST4, the session information processing system 6 acquires, as session information, information on the registered item tentatively selected by the subject user from the plurality of registered items tentatively proposed to the subject user from the item proposer 7 via the user interface 2 of the subject user in the previous step ST3 (selection process), and the process proceeds to step ST5.

In step ST5, the session information processing system 6 counts up the counter n by 1 (n=n+1), and the process proceeds to step ST6.

In step ST6, the session information processing system 6 determines whether the value of the counter n is equal to or greater than the number of times of setting Nset. When it is determined to be NO in step ST6, the process returns to step ST3, and when it is determined to be YES, the process proceeds to step ST7. In other words, the session information processing system 6 and the item proposer 7 alternately and repeatedly executes the proposal process (step ST3) and the selection process (step ST4) for the number of times of setting Nset.

In step ST7, the session information processing system 6 updates the target social position and the session vector for the subject user based on the latest session information, and transmits the target social position and the session vector to the item proposer 7.

In step ST8, the item proposer 7 generates a proposal list based on the match-pair list, the target social position, and the session vector, and proposes registered items included in the proposal list to the subject user via the user interface 2 (final proposal process), and the process proceeds to step ST9.

In step ST9, the session information processing system 6 sets, as a confirmation item, the registered item finally selected by the subject user from the plurality of registered items finally proposed to the subject user from the item proposer 7 in previous step ST8 via the user interface 2 of the subject user, and the processing shown in FIG. 13 ends.

According to the information providing system 1 and the information providing method of the present embodiment, the following effects are achieved.

(1) In the information providing system 1, the item list generator 55 generates the match-pair list including one or more registered items associated with the subject user, based on the personal information on the subject user registered in the user profile database 51 and the item information on each of the registered items registered in the item profile database 52, the session information processing system 6 acquires the session information in the session with the subject user via the user interface 2 of the subject user and calculates the target social position of the subject user in the social space formed by reflection of the sense of values of the plurality of registered users based on the session information, and the item proposer 7 proposes one or more items based on the match-pair list and the target social position. According to the information providing system 1 and the information providing method make it possible to propose the items with a high level of satisfaction to a large number of users who mainly belong to a follower group, by first proposing the items to the subject user using the match-pair list generated based on the information registered in the user profile database 51 and the item profile database 52.

Further, according to the information providing system 1 and the information providing method, the session information processing system 6 can calculate, as the target social position, the “goal” according to the above-mentioned personality model for the subject user at the time of execution of the session by calculating the target social position of the subject user in the social space based on the session information acquired in the session with the subject user. Further, according to the information providing system 1 and the information providing method, the item proposer 7 proposes the items to the subject user based on the match-pair list and the target social position, and thus can also propose the items with a high level of satisfaction to users who belong to a superfan group, an advanced group, a standard group, or the like other than a follower group.

(2) The session information processing system 6 can acquire, as the session information, the information on the item selected by the subject user as the session information in the session with the subject user including the repetition of the proposal process and the selection process for several times, and can calculate the target social position based on the session information, thereby calculating the target social position of the subject user while reflecting the sense of values of the subject user at the time of execution of the session, for example, a hobby, a taste, and an interest. This feature makes it possible to propose the items with a high level of satisfaction to more users.

(3) The session information processing system 6 can calculate the target social position based on the change history of the social position of the subject user in the social space within the session, and can calculate the target social position of the subject user while accurately reflecting the sense of values of the subject user at the time of execution of the session. This feature makes it possible to propose the items with a high level of satisfaction to more users.

(4) The user vector generator 62 generates the user vectors for the registered users on a user-by-user basis, based on the personal information registered in the user profile database 51, and the user vector storage 60 stores the user vectors generated by the user vector generator 62. In the information providing system 1 and the information providing method, the session information processing system 6 defines the social space, in which the target social position is defined, based on the user vectors of the plurality of registered users. This feature makes it possible to define the social space while reflecting the sense of values of a virtual society constituted by the plurality of registered users registered in the user profile database 51.

(5) The item vector generator 63 generates the item vectors for the registered items on an item-by-item basis, based on the item information registered in the item profile database 52, the item vector storage 61 stores the item vectors generated by the item vector generator 63, and the item proposer 7 proposes one or more items to the subject user based on the item vector and the target social position associated with each other by the match-pair list. This feature makes it possible to quantitatively extract, from the plurality of items included in the match-pair list, items that increase the “level of well-being” referred to in the personality model, and to propose the extracted items to the subject user.

(6) The user vector updater 64 updates the user vector of the subject user stored in the user vector storage 60 based on the session information. This feature makes it possible to cause the user vector of the subject user to reflect the sense of values of the subject user at the time of execution of the session.

(7) The user vector updater 64 updates the user vector of the subject user based on the item vector associated with the session information. This feature makes it possible to quantitatively evaluate the sense of values of the subject user at the time of execution of the session and to cause the user vector of the subject user to reflect the sense of values.

(8) The value of the registered item in a society as a whole is not universal from when the registered item is registered in the item profile database 52, and changes from moment to moment as the sense of values of the society as a whole changes. Therefore, the item vector updater 65 updates the selected item vector associated with the session information of the subject user among the plurality of item vectors stored in the item vector storage 61, based on the user vector of the subject user. Thus, the item vectors can be updated in accordance with the change in the sense of values of the society as a whole, that is, so that the item vectors follow the whims of fashion. This feature makes it possible to maintain the item vectors stored in the item vector storage with high freshness. Maintaining the item vectors with high freshness in this way enables proposal of the items with a high level of satisfaction to the subject user.

(9) The sense of values of the society as a whole changes from moment to moment, regardless of changes in the sense of values of oneself as a member of the society. In particular, the sense of values of the users, who belong to the superfan group or the advanced group, change dramatically, and the sense of values of the society as a whole changes accordingly. To address these changes, according to the information providing system 1 and the information providing method, the centroid boundary calculator 66 calculates centroids and boundaries of the user vector space of the user vectors of the plurality of registered users stored in the user vector storage 60, and the session information processing system 6 defines the social space based on the centroids and boundaries of the plurality of registered users. Thus, since the social space can be defined in accordance with the changes in the sense of values of the society as a whole, the social position of the subject user in the society as a whole can be corrected in accordance with changes in the sense of values of the society as a whole.

(10) The social position calculator 67 calculates the social position of the subject user in the social space based on the user vector of the subject user, the session vector generator 68 generates the session vector based on the change history of the social position of the subject user within the session, and the target social position calculator 69 calculates the target social position based on the session vector obtained by reflection of the social position of the subject user and the change history of the social position. This feature makes it possible to calculate an appropriate target social position that reflects the sense of values of the subject user at the time of execution of the session.

(11) The target social position calculator 69 calculates the target social position by synthesizing a latest social position of the subject user and the change target of the social position of the subject user estimated based on the session vector. Thus, since the target social position can be calculated based on latent needs that the subject user him/herself cannot recognize, thereby making it possible to propose to the subject user the items with a high level of satisfaction that is personalized to each individual.

(12) The item proposer 7 calculates the score for each of the items included in the item list, based on the target social position, the session vector, and the item vector, and proposes the items in descending order of the score, thereby making it possible to propose the items in descending order of the level of satisfaction.

Although the embodiment of the present invention has been described above, the present invention is not limited thereto. Detailed configurations may be changed as appropriate within the scope of the present invention.

What is claimed is:

1. An information providing system for proposing an item suitable for a subject user out of a plurality of registered items registered in an item profile database, the information providing system comprising:
an item list generator that generates an item list including one or more items associated with the subject user based on information on the subject user registered in a user profile database and information registered in the item profile database;
a session information processing system that acquires session information in a session with the subject user via a user interface of the subject user, and calculates a target social position of the subject user in a social space formed by reflection of sense of values of a plurality of registered users registered in the user profile database, based on the session information; and
an item proposer that proposes one or more items to the subject user based on the item list and the target social position.

2. The information providing system according to claim 1, wherein the session includes repeating several times a proposal process in which the item proposer tentatively proposes a plurality of items to the subject user and a selection process in which the subject user tentatively selects at least one item from the plurality of items proposed by the item proposer, and
the session information includes information on the items selected by the subject user in the selection process.

3. The information providing system according to claim 2, wherein the session information processing system calculates the target social position based on a change history of a social position of the subject user in the social space within the session.

4. The information providing system according to claim 3, wherein the session information processing system includes:
a user vector generator that generates user vectors for the registered users on a user-by-user basis, based on information registered in the user profile database; and
a user vector storage that stores the user vectors generated by the user vector generator, and
the social space is defined based on the user vectors of the plurality of registered users.

5. The information providing system according to claim 4, wherein the session information processing system includes:
an item vector generator that generates item vectors for the registered items on an item-by-item basis, based on information registered in the item profile database; and
an item vector storage that stores the item vectors generated by the item vector generator, and
the item proposer proposes one or more items to the subject user based on the item vector and the target social position associated with each other by the item list.

6. The information providing system according to claim 5, wherein the session information processing system further includes a user vector updater that updates, based on the session information, the user vector of the subject user stored in the user vector storage.

7. The information providing system according to claim 6, wherein the user vector updater updates the user vector of the subject user based on an item vector associated with the session information.

8. The information providing system according to claim 5, wherein the session information processing system further includes an item vector updater that defines an item vector associated with the session information as a selected item vector and updates the selected item vector stored in the item vector storage, based on the user vector of the subject user.

9. The information providing system according to claim 8, wherein the session information processing system further includes a centroid boundary calculator that calculates a centroid and a boundary of a user vector space of the user vectors of the plurality of registered users stored in the user vector storage, and
the social space is defined based on the centroid and the boundary.

10. The information providing system according to claim 9, wherein the session information processing system further includes:
a social position calculator that calculates a social position of the subject user in the social space based on the user vector of the subject user;
a session vector generator that generates a session vector based on a change history of the social position of the subject user within the session; and
a target social position calculator that calculates the target social position based on the social position of the subject user and the session vector.

11. The information providing system according to claim 10, wherein the target social position calculator calculates the target social position by synthesizing a latest social position of the subject user and a change target of the social position of the subject user estimated based on the session vector.

12. The information providing system according to claim 10, wherein the item proposer calculates a score for each of the items included in the item list based on the target social position, the session vector, and the item vector, and proposes the items in descending order of the score.

13. An information providing method for proposing, by a computer, an item suitable for a subject user out of a plurality of registered items registered in an item profile database, the information providing method comprising:
generating an item list including one or more items associated with the subject user based on information on the subject user registered in a user profile database and information registered in the item profile database;
acquiring session information in a session with the subject user via a user interface of the subject user;
calculating a target social position of the subject user in a social space formed by reflection of sense of values of a plurality of registered users registered in the user profile database, based on the session information; and
proposing one or more items to the subject user based on the item list and the target social position.

14. The information providing system according to claim 1, wherein the session information processing system calculates the target social position based on a change history of a social position of the subject user in the social space within the session.

15. The information providing system according to claim 14, wherein the session information processing system includes:
a user vector generator that generates user vectors for the registered users on a user-by-user basis, based on information registered in the user profile database; and
a user vector storage that stores the user vectors generated by the user vector generator, and
the social space is defined based on the user vectors of the plurality of registered users.

16. The information providing system according to claim 15, wherein the session information processing system includes:
an item vector generator that generates item vectors for the registered items on an item-by-item basis, based on information registered in the item profile database; and
an item vector storage that stores the item vectors generated by the item vector generator, and
the item proposer proposes one or more items to the subject user based on the item vector and the target social position associated with each other by the item list.

17. The information providing system according to claim 16, wherein the session information processing system further includes a user vector updater that updates, based on the session information, the user vector of the subject user stored in the user vector storage.

18. The information providing system according to claim 17, wherein the user vector updater updates the user vector of the subject user based on an item vector associated with the session information.

19. The information providing system according to claim 1, wherein the session information processing system includes:
a user vector generator that generates user vectors for the registered users on a user-by-user basis, based on information registered in the user profile database; and
a user vector storage that stores the user vectors generated by the user vector generator, and
the social space is defined based on the user vectors of the plurality of registered users.

20. The information providing system according to claim 19, wherein the session information processing system includes:
an item vector generator that generates item vectors for the registered items on an item-by-item basis, based on information registered in the item profile database; and
an item vector storage that stores the item vectors generated by the item vector generator, and
the item proposer proposes one or more items to the subject user based on the item vector and the target social position associated with each other by the item list.
